(19) United States
(12) Patent Application Publication
(10) Pub. No.: US 2024/0242408 A1
(43) Pub. Date: Jul. 18, 2024

(54) IDENTITY PRESERVATION AND STYLIZATION STRENGTH FOR IMAGE STYLIZATION

(71) Applicants: Konstantin Gudkov, Playa Vista, CA (US); Andrey Alejandrovich Gomez Zharkov, Los Angeles, CA (US)

(72) Inventors: Konstantin Gudkov, Playa Vista, CA (US); Andrey Alejandrovich Gomez Zharkov, Los Angeles, CA (US)

(21) Appl. No.: 18/411,551

(22) Filed: Jan. 12, 2024

Related U.S. Application Data
(60) Provisional application No. 63/479,914, filed on Jan. 13, 2023.

(51) Int. Cl. G06T 11/60; G06T 5/50; G06T 7/00; G06V 10/44; G06V 10/74; G06V 10/771; G06V 40/16

(52) U.S. Cl. CPC G06T 11/60; G06T 5/50; G06T 7/0002; G06V 10/44; G06V 10/761; G06V 10/771; G06V 40/171; G06T 2207/20221; G06T 2207/30168

(57) ABSTRACT

A computer-implemented method and system that constructs a set of target domain images, trains an image generation model using this set, uses the trained model to generate paired images such as target domain images paired with source domain images, evaluates a quality of the paired image set, constructs an adjusted paired image set based on the evaluated quality, and generates output target domain images using an image translation model trained on the adjusted set. A computer-implemented method and system that constructs an augmented set of target domain images including condition labels, uses it to train a conditional image producing model, generates two feature maps at a layer of the trained image producing label by using two input sets including two conditional labels, and uses the feature maps and mask to compute a combined feature map subsequently used to generate output target domain images by the trained image producing model.

### CROSS REFERENCE TO RELATED APPLICATIONS

This patent application claims the benefit of priority, under 35 U.S.C. Section 119(e), to U.S. Provisional Patent Application Ser. No. 63/479,914, entitled “COMBINING IDENTITY PRESERVATION AND STYLIZATION STRENGTH FOR IMAGE STYLIZATION EFFECTS”, filed on Jan. 13, 2023, which is hereby incorporated by reference in its entirety.

### TECHNICAL FIELD

The disclosed subject matter relates generally to the technical field of image processing and, in one specific example, to an image stylization system.

### BACKGROUND

Many popular applications offer image stylization features that transform images from a source domain into a stylized representation from a target domain. To achieve a desired stylization effect, a subset of image features are altered as needed while others remain recognizable. Image stylization effects have high user engagement and can lead to improved user retention for image capture and/or sharing applications, messaging platforms, social media applications, or technology platforms more broadly.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system according to some examples.

FIG. 3 is a diagrammatic representation of a data structure as maintained in a database, according to some examples.

FIG. 4 is a diagrammatic representation of a message, according to some examples.

FIG. 5 is a diagrammatic representation of an image stylization system, according to some examples.

FIG. 6 is an illustration of image stylization outputs, according to some examples.

FIG. 7 is a flowchart illustrating a process flow for an image stylization system, according to some examples.

FIG. 8 is an illustration of outputs of image generation models, according to some examples.

FIG. 9 is an illustration of feature sets for two sets of images, according to some examples.

FIG. 10 is an illustration of effects of adding a custom loss to a base loss in model training, according to some examples.

FIG. 11 is a flowchart illustrating an image combination method, according to some examples.

FIG. 12 is an illustration of image combination outputs, according to some examples.

FIG. 13 is a flowchart illustrating part of an image combination method, according to some examples.

FIG. 14 is a flowchart illustrating part of an image combination method, according to some examples.

FIG. 15 is an illustration of outputs of an image combination method, according to some examples.

FIG. 16 is a diagrammatic representation of a machine in the form of a computer system within which a set of instructions may be executed to cause the machine to perform any one or more of the methodologies discussed herein, according to some examples.

FIG. 17 is a block diagram showing a software architecture within which examples may be implemented.

FIG. 18 is a flowchart for an access-limiting process, according to some examples.

### DETAILED DESCRIPTION

Many popular applications offer image stylization features or effects for transforming an image from a source domain into a stylized representation from a target domain. A source domain can include human faces, human bodies, real world photographs, natural objects, animals, and so forth. A target domain can include statues, portraits, smiling faces, anime effects, zombie effects, or other effects. For example, stylization effects can include transforming a human or a human face into a statue, such as a bronze statue or a marble statue. Stylization effects and/or resulting stylized images have properties such as identity preservation and stylization strength.

Identity preservation refers to how recognizable an entity represented in the image remains after the transformation. The entity can be the subject of the image, a core element or attribute of the image, and so forth. A stylization effect or a stylized image that allows an entity from the input image to remain highly recognizable exhibits high identity preservation. For instance, a person featured in an input image can remain recognizable, after stylization, based on facial features, expressions, skin tone, hair aspect and/or structure, or other features that are similar between the input image and the stylized image. A stylization effect or stylized image that does not allow a featured entity from the input image to remain highly recognizable exhibits low identity preservation. A low identity preservation image can have characteristics of the target domain. For instance, given a portrait stylization effect, the stylized image can be a portrait image that exhibits low identity preservation when it resembles someone else's portrait.

Stylization strength refers to how close stylized images are to the target domain; it characterizes the degree to which they exhibit characteristics of the target domain. High stylization strength characterizes output images that exhibit many of the target domain's characteristics, while low stylization strength characterizes output images that only partially or barely exhibit characteristics of the target domain. For example, high stylization strength for a smile stylization effect can correspond to a stylized image showing a strong or wide smile, while low stylization strength may correspond to a stylized image showing a light smile. In some cases, such images may fall between the source and target domains.

A user's experience is improved if a stylization effect or stylized image has high stylization strength and/or high identity preservation. Some users may want to balance stylization strength and identity preservation or prefer one characteristic over the other. Existing stylization solutions are insufficient for producing stylized images that exhibit high stylization strength and high identity preservation. Furthermore, they are insufficient with respect to varying stylization strength and identity preservation levels, to accommodate the requirements of specific use cases or specific users.

Examples in the disclosure herein refer to an image stylization system that enables a nuanced and customizable approach to image stylization. The image stylization system refines image generation and image translation pipelines using iterative training and/or iterative training set construction options. The image stylization system guides image generation and/or image translation models towards desired image properties using custom loss functions as part of model training. The image stylization system can combine images with different properties in order to achieve a desired overall balance of properties for an output image. Image combination methods can include direct, image-level combination, as well as image combination at the level of feature maps generated by conditional image producing models. By using one or more of the above techniques, the image stylization system can achieve both identity preservation and stylization strength for stylized images. Additionally, the levels of identity preservation and/or stylization strength can be varied and/or controlled as needed for the benefit of users and/or downstream applications. In some examples, the image stylization system implements such techniques or solutions by improving, modifying and/or repeating one or more core operations, as described in the following.

As part of a core set of operations, the image stylization system collects an image dataset from a target domain, corresponding for example to a desired stylization (e.g., generating “marble statue” images). The image stylization system trains an image generation model on the set of collected images for the target domain. In some examples, the image generation model is pre-trained on images from a source domain (e.g., human faces). The image stylization system uses the trained image generation model to generate paired images, each pair including a source domain image and a target domain image. An example pair can include, for example, an image of a human face and a stylized image of the human face as a marble statue. The image stylization system can train an image translation model (e.g., an image-to-image translation model) on the dataset of paired images. Given input images from the source domain, the image stylization system can run the trained image translation model to produce corresponding stylized images. In some examples, the image stylization model can augment this set of core operations, by using other types of image producing models (e.g., in addition to image generation models and/or image translation models) and/or other operations.

In some examples, the image stylization system repeats one or more core operations to balance and/or vary identity preservation and/or stylization strength for a particular stylization effect. The one or more core operations can be repeated one or more times. For example, after completing the training of the image generation model using target domain images, the image stylization system can sample output images produced by the trained image generation model. The system can train a second image generation model using the sampled output, where the second image generation model can exhibit better identity preservation and/or lower stylization strength. The sampling and/or retraining operations can be repeated, resulting in multiple additional image generation models and/or multiple sets of output images on a spectrum of low to high identity preservation and/or low to high stylized strength. In some examples, the image stylization system can train an image translation model as described above, and then use similar successive training or retraining operations. For example, images sampled from the output of a trained image translation model can be used to train a new image generation model, used to train a new image translation model, or used to re-train the trained image translation model.

In some examples, the image stylization system modifies the training regime of the one or more image generation models and/or image translation models by adding a regularization loss term during training. For example, the image stylization system adds a custom loss term to a base or default loss function while training the one or more models. An example custom loss term is a consistency loss term that enforces identity preservation requirements. Such a loss term can be computed by penalizing mismatching image features between two sets of images. Example image features include landmarks or facial keypoints, blend shapes (estimated features for facial shape and expression), features based on face recognition network embeddings, or other features. In some examples, the first set of images includes source domain images generated during an initialization of a pre-trained image generation model, while the second set includes candidate target domain images generated during training or fine-tuning the image generation model in the context of the target domain. In some examples, the two sets of images correspond, respectively, to a set of source domain images provided as input to an image translation model, and to a set of target domain images generated during the training of the image translation model.

In some examples, the image stylization system can obtain output images from a target domain with desired characteristics and/or image attributes using an image-level combination method. In some examples, the image stylization system can seek to combine a first image with high stylization strength and low identity preservation with a second image with low stylization strength and high identity preservation. Such images can be obtained using sufficient repetitions of one or more core operations, as previously described. For example, images with different levels of identity preservation and/or stylization strength can be obtained by training multiple image generation models or multiple image translation models. In some examples, a source image can be used as an extreme example of an image with low stylization strength and high identity preservation. In some examples, the image stylization system detects or is provided with the information that an image attribute (e.g., teeth shape, eye shape or other identity preservation-related attributes) has a satisfactory appearance in a first image, and/or an unsatisfactory appearance in a second image. In some examples, the image stylization system can seek to retain content from a second image with high stylization strength.

The image stylization system can combine the first image and the second image, retaining the desired attribute from the first image, where it is well-preserved or represented. To preserve an attribute, the image stylization system computes a mask corresponding to an attribute's location with respect to an image, such as the area inside a person's lips in case of a teeth shape attribute. In some examples, the image stylization system combines the first image, the second image and the mask (e.g., using alpha blending or Poisson blending). The combined image will exhibit both high stylization strength and high identity preservation. The image stylization system can execute the image combination procedure multiple times and/or for multiple pairs of images, thus creating multiple combined images with high identity preservation and high stylization strength for a desired target domain, and/or multiple combined images with the desired combination of image attributes. In some examples, these combined images can be used as part of constructing or augmenting training sets for the training or re-training of image generation models and/or image translation models, as described above.

In some examples, the image stylization system combines images at the level of feature maps produced by conditional models. The image stylization system can use conditional image producing models, such as conditional image generation models or conditional image translation models, to achieve both stylization strength and identity preservation, and/or reduce artifacts on the borders of preserved features, among other potential uses. As above, the image stylization system can seek to combine an image with a high stylization strength and low identity preservation with an image with low stylization strength and high identity preservation. In some examples, the image stylization model trains a conditional image producing model on an augmented training dataset including information such as (conditionLabelᵢ, images satisfying conditionLabelᵢ) for a given set of conditions A condition label or value can be a single floating-point number, such as 0 for low stylization strength or 1 for high stylization strength. Each condition label is matched with appropriate images. For example, condition labels indicating different levels of image stylization strength are matched to appropriate images based on their stylization strength level.

The trained conditional image producing model is provided with appropriate model inputs for the model type, where model input values are fixed, except the condition input. In some examples, the trained conditional model fixes the condition input label to be 0 (e.g., for low stylization strength), and produces a first set of representations and/or a first output image. In some examples, the trained conditional model fixes the condition input label to be 1 (e.g., for high stylization strength), and produces a second set of representations and/or a second output image. The image stylization system can compute a mask based on the two sets of image representations and/or on the first output image and second output image. The trained conditional model can run layer-by-layer using both the (fixed model inputs, conditionLabel=0) configuration and the (fixed inputs, conditionLabel=1) configuration. Feature maps generated during this inference run at a selected layer can be combined using the mask, with the combined feature map being propagated to the next layer(s), and/or eventually used to produce an output or combined image. The output or combined image generated in this manner has high identity preservation and high stylization strength.

### Networked Computing Environment

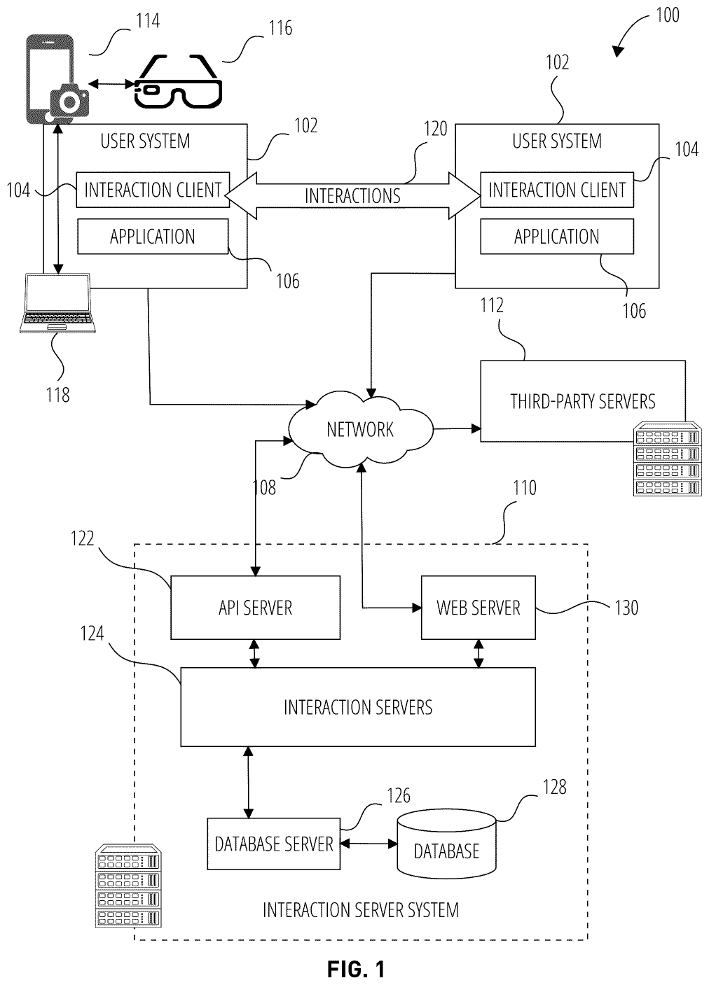

FIG. 1 is a block diagram showing an example interaction system 100 for facilitating interactions (e.g., exchanging text messages, conducting text audio and video calls, or playing games) over a network. The interaction system 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the client systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

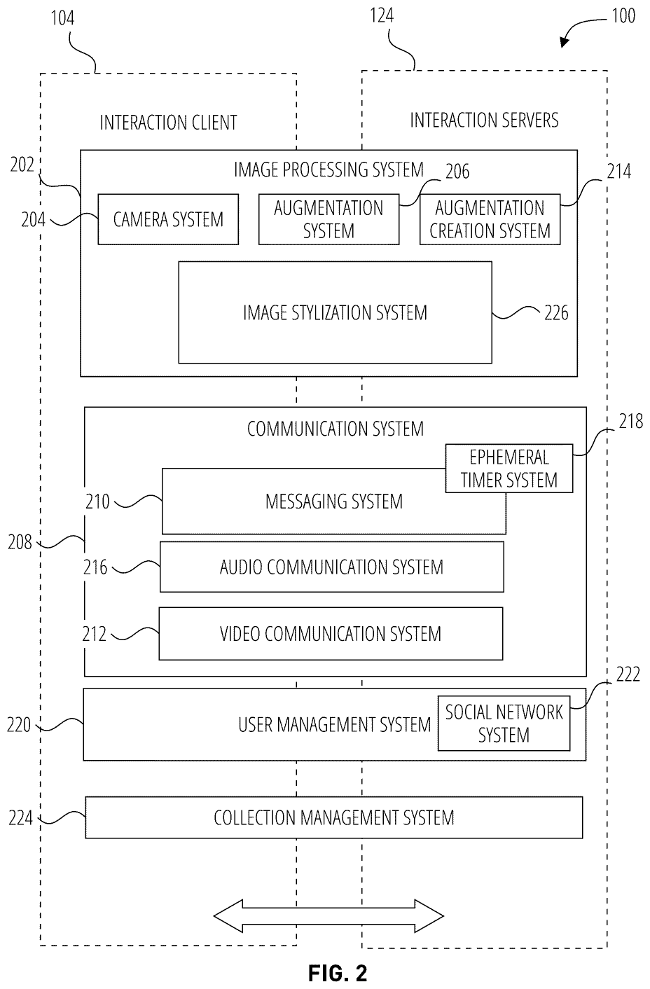

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from a memory of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

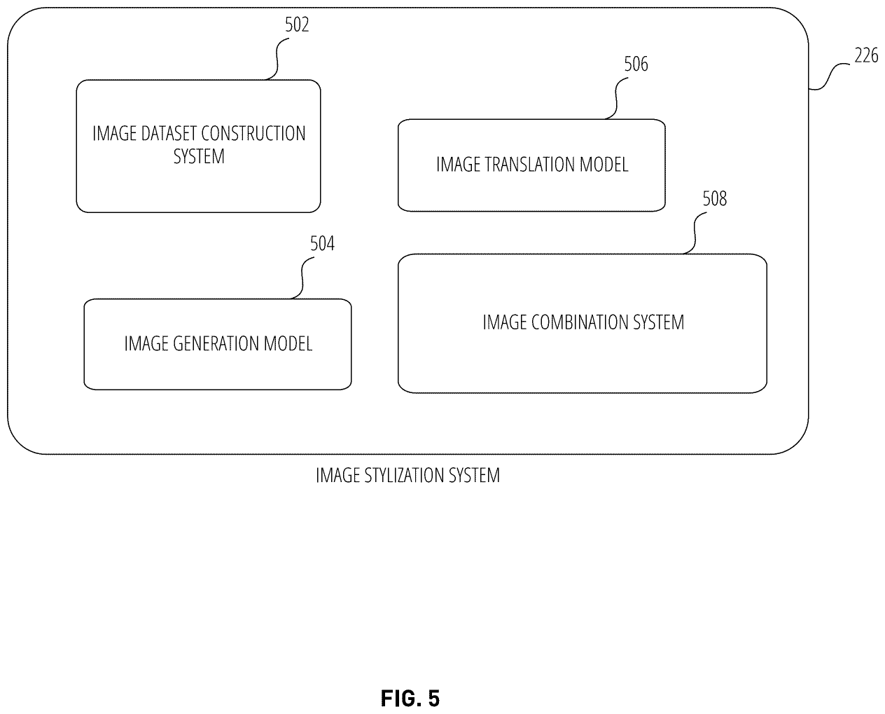

An image stylization system 226 effectuates a transformation of an image in a source domain into a stylized image in a target domain of interest (see FIG. 5 for a view of an image stylization system 226).

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system 218) that, based on duration and display parameters associated with a message or collection of messages (e.g., a story), selectively enable access (e.g., for presentation and display) to messages and associated content via the interaction client 104. Further details regarding the operation of the ephemeral timer system 218 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 220 is operationally responsible for the management of user data and profiles, and includes a social network system 222 that maintains information regarding relationships between users of the interaction system 100.

A collection management system 224 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 224 may also be responsible for publishing an icon that provides notification of a particular collection to the user interface of the interaction client 104. The collection management system 224 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 224 employs machine vision (or image recognition technology) and content rules to curate a content collection automatically. In certain examples, compensation may be paid to a user to include user-generated content into a collection. In such cases, the collection management system 224 operates to automatically make payments to such users to use their content.

An external resource system provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A Web ViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system operationally enables the purchasing of advertisements by third parties for presentation to end-users via the interaction clients 104 and also handles the delivery and presentation of these advertisements.

### Data Architecture

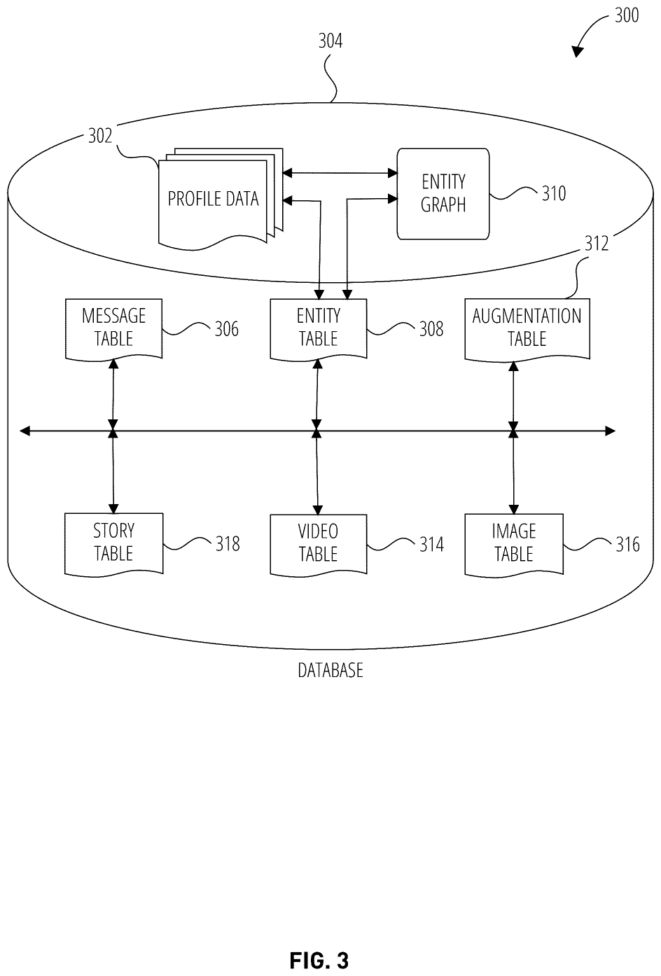

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate with at a particular time.

Where the entity is a group, the profile data 302 for the group may similarly include one or more avatar representations associated with the group, in addition to the group name, members, and various settings (e.g., notifications) for the relevant group.

Database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

### Data Communications Architecture

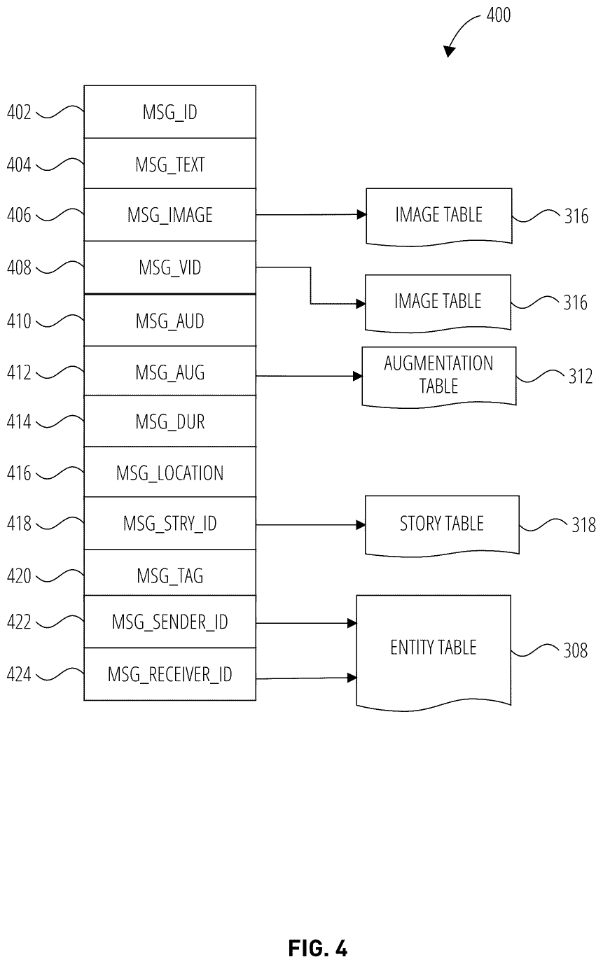

FIG. 4 is a schematic diagram illustrating a structure of a message 400, according to some examples, generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more content collections (e.g., “stories” identified in the story table 318) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a story table 318, and values stored within the message sender identifier 422 and the message receiver identifier 424 may point to user records stored within an entity table 308.

### An Image Stylization System

FIG. 5 is a diagrammatic representation of an image stylization system 226, according to some examples. The image stylization system 226 has several modules and components including an image dataset construction system 502, an image generation model 504, an image translation model 506, and an image combination system 508. In some examples, an image stylization system 226 has additional, or fewer, modules or components. In some examples, the image stylization system includes multiple components of the same type, such as multiple image generation or multiple image translation models.

The image stylization system 226 implements stylization effects, consisting of transformations of images in a source domain to stylized images in a target domain. The source domain can include human faces or bodies, real world photographs, or other entities or artifacts. The target domain can include marble or bronze statues, smiling or frowning versions of human faces, anime, zombie or ghost versions of human faces, a different object category than that depicted in the source image, such as a vehicle rather than a human or an animal, and so forth. The image stylization system 226 can apply multiple stylization effects to a source image, and/or produce multiple output stylized images, or one stylized image illustrating multiple effects (e.g., a “smiling marble statue”, etc.).

A stylization effect has properties such as stylization strength and/or identity preservation. The image stylization system 226 produces stylized images with combinations of values for such properties. For example, the image stylization system 226 can aim for high stylized strength and high identity preservation.

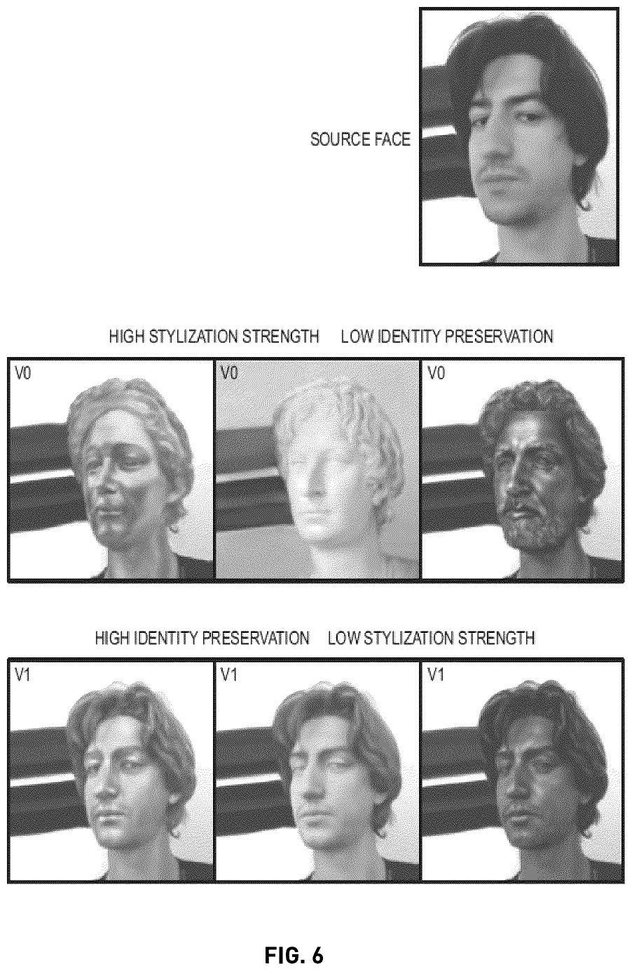

In some examples, stylization strength refers to how close a stylized image is to the target domain. A stylized image with high stylization strength is an image that shares enough characteristics of the images in the target domain to be considered a target domain image. For example, FIG. 6 illustrates example stylized images “v0” that belong to the example target domains (marble statues, bronze statues, etc.). An image with low stylization strength does not exhibit enough of the desired characteristics of the target domain. For example, the “v1” examples in FIG. 6 illustrate images with low stylization strength.

In some examples, identity preservation refers to how recognizable a subject, attribute or entity of a source domain image remains in a transformed, stylized image generated by the image stylization system 226. Identity preservation for human faces can be assessed based on the similarity of facial features, facial expression, skin tone, hair aspect (color, texture, structure), or other attributes. Identity preservation for human bodies can be assessed based on features used to assess face identity preservation, on posture or structure similarity, or on other features. A stylized image with high identity preservation is one that retains enough of the characteristics of a core entity in the input image to keep it recognizable (see, e.g., the “v1” examples in FIG. 6). A stylized image with low identity preservation is one in which a core entity of the input image is no longer recognizable, or could be difficult to recognize (see, e.g., the “v0” examples in FIG. 6).

While the disclosure herein uses identity preservation and/or stylization strength as illustrative examples, stylization effects and/or stylized images can be further characterized using additional properties such as color harmony, global illumination consistency, semantic consistency (e.g., maintenance of meaning and context of objects and/or scenes within the image), depth perception, or other properties. Such properties can also be handled by the image stylization system described herein, either directly or by modifying system components by a person with ordinary skill in the art.

### Image Dataset Construction System

The image stylization system 226 includes an image dataset construction system 502 that collects, accesses, or modifies image datasets for one or more image domains. An image dataset construction system 502 provides image datasets to, and receives image datasets from, other components of the image stylization system, such as an image generation model 504 or an image translation model 506.

In some examples, an image dataset construction system 502 automatically accesses a provided set of images from a domain of interest, the images being provided by a developer, a third party, or other sources. In some examples, image dataset construction system 502 automatically collects a set of images from a domain of interest using one or more available tools or resources. The domain of interest can include a desired image style, object or scene category. The tools and/or resources can include APIs to labeled image repositories, pre-trained image classification models used to label unlabeled image data, or other resources or tools.

In some examples, the image dataset construction system 502 evaluates an image dataset with respect to one or more predetermined criteria to identify whether an image dataset should be modified or replaced. In some examples, the evaluation is conducted by automatically sampling a subset of an image dataset and presenting it to a human annotator for receiving one or more quality indicators (e.g., via one or more user selectable elements in a user interface (UI)). A quality indicator can correspond to a numerical or categorical feature value that characterizes or denotes the presence, absence and/or degree thereof of a desired image quality such as identity preservation, stylization strength, and so forth. Examples of feature values include a single floating-point number, a selected number on a scale of 1-5, with 1 indicating the lowest level of a quality and 5 the highest level of a quality, a binary value such as 0 or 1, a categorical feature value such as “low” or “high”, or other examples.

In some examples, the evaluation is conducted by automatically analyzing one or more images in an image dataset using a model that identifies the degree of presence of a quality of interest, or the degree of presence of a second quality that is a proxy for, or correlated with, the quality of interest. For example, an image-based or image-region-based color cohesiveness measure can be correlated with high or low stylization strength for a marble statue or a bronze statue stylization effect. In some examples, an automatic analysis can indicate that an image dataset size is too small with respect to a pre-determined needed dataset size, or that a dataset diversity indicator is lower than a predetermined threshold.

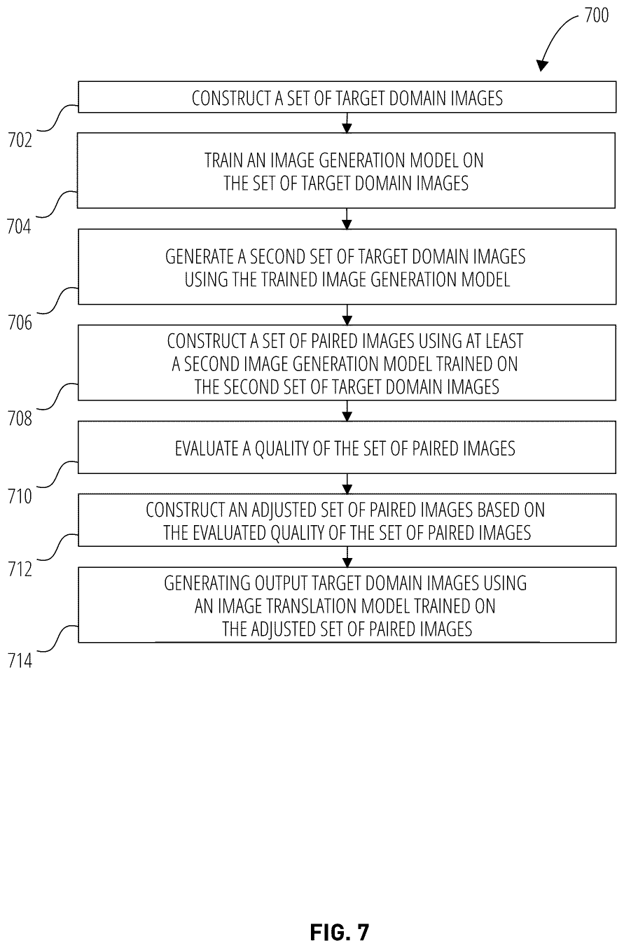

If the evaluation with respect to one or more criteria and/or pre-specified quality of the dataset indicates that the dataset should be modified or replaced, the image dataset construction system 502 can use one or more of the image generation model 504, image translation model 506, or other components of the image stylization system 226 to adjust the dataset (see, e.g., FIG. 7 for more details).

### Image Generation Model

The image stylization system 226 uses one or more image generation models 504 to generate images from a source domain, images from a target domain, or to generate paired (source, target) images, where source images correspond to a source domain and target images correspond to a target domain. Image generation models 504 are examples of image producing models (other examples including image translation models 506, among other models). An image generation model 504 corresponds to, or can use, one or more machine learning (ML) models. The image generation model 504 can use one or more unsupervised models, semi-supervised models, or supervised models. The image generation model 504 can use a Generative Adversarial Network (GAN) (e.g, Deep Generative Adversarial Network, Deep Convolutional GAN (DCGAN), U-Net GAN and so forth). The image generation model 504 can use one or more generators (e.g., the first component of a generator/discriminator architecture). In the disclosure herein, fine-tuning, training or running an image generation model 504 refers to either fine-tuning, training or running the image generation model itself, and/or training or running one or more ML models used by the image generation model 504.

In some examples, image generation model 504 uses a model (e.g., a GAN) pre-trained on a first domain, such as a source domain. The pre-trained model can take input noise and generate an image from the pre-training domain, such as a source domain image. In some examples, image generation model 504 can train or fine-tune the pre-trained model to produce stylized, target domain images. As part of training or fine-tuning in the context of the target domain, the model generates candidate target domain images based on input noise. In some examples, image stylization system 226 can use one or more image generation models 504 to generate pairs of related images. For example, each pair can include a source domain image (e.g., generated during the initialization of the pre-trained model), and a candidate target domain image (e.g., generated during training or fine-tuning of the model), the two images being generated based on the same input noise. In some examples, the image generation model 504 uses a first ML model pre-trained on the first domain (e.g., the source domain) and trains a second ML model on a target domain (with the first and second model being the same or different). In some examples, a first image generation model 504 can use the first ML model pre-trained on the first domain (e.g., the source domain), and a second image generation model 504 can train the second ML model on the target domain (with the first and second image generation models 504 being the same and/or different, and with the first and second ML models being the same or different).

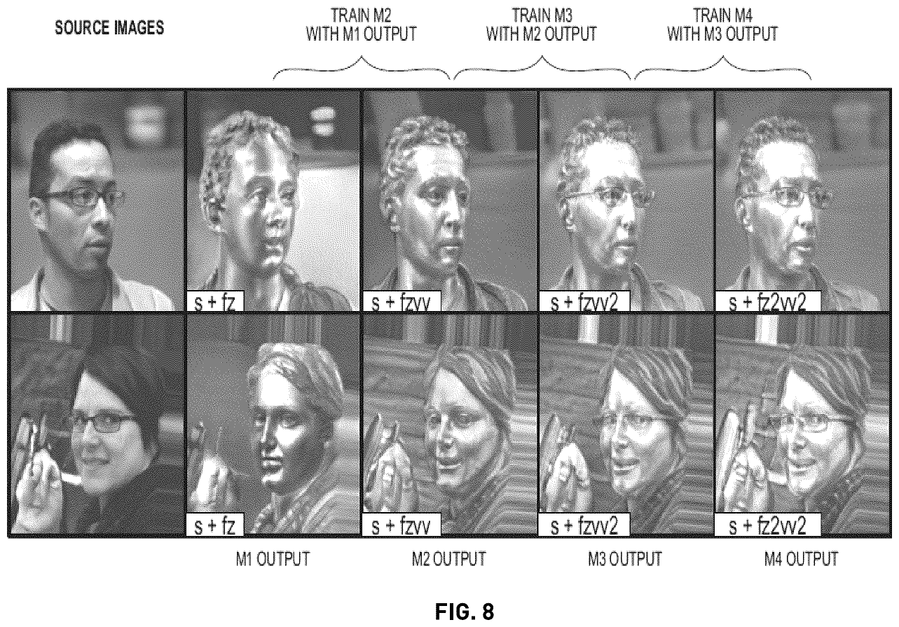

The image stylization system 226 can use one or more image generation models 504. A first image generation model 504 trained on the target domain can generate a set of output target domain images that are incorporated by an image dataset construction system 502 into a new training set for the target domain. The new training set is in turn used to train a second image generation model 504. This step can be repeated one or more times to produce multiple sets of candidate target domain images with varying stylization strength and/or identity preservation levels (see, e.g., FIG. 7 and FIG. 8 for details).

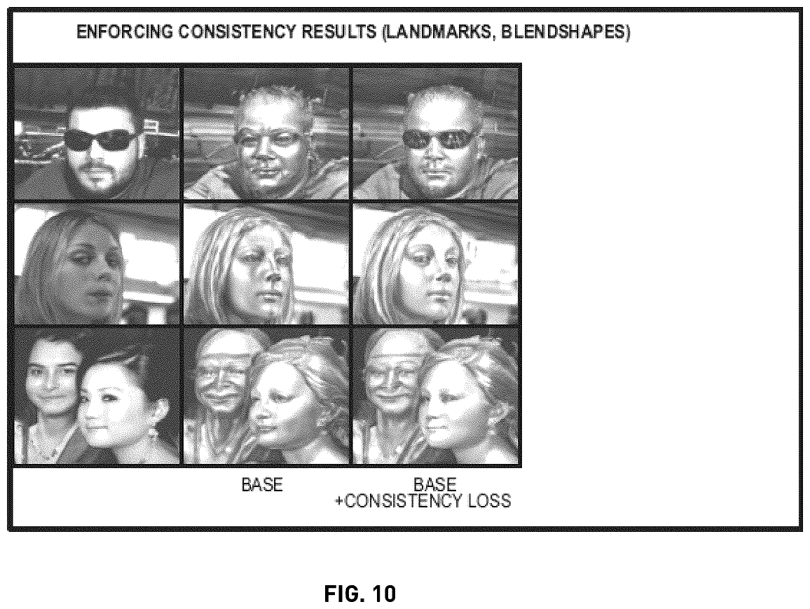

Regularization Losses in Model Training In some examples, image stylization system 226 modifies a training regime of an image generation model 504 by adding constraints that enhance one or more qualities of a generated image, such as identity preservation or other qualities. Training an image generation model 504 minimizes a loss function. The image stylization system 226 can augment a default loss function by adding a custom loss term, such as consistency-enforcing or identity-enforcing loss that penalizes a mismatch between features of a source domain image and corresponding features of a candidate target domain image generated during training. Modifying and/or explicitly guiding the training of the image generation model 504 by adding such a custom loss enhances, for example, the identity preservation properties of the trained model (see, e.g., FIG. 10).

Example features include identity features or identity-preservation related features. Identity-related features include facial landmarks (facial keypoints, such as the location of a nose tip or eye corner), blend shapes, face embeddings such as face descriptors extracted at layer(s) of a pre-trained face recognition model (e.g., VGGFace, VGGFace2, other face recognition models), or other features. The features can be computed in a differentiable manner, to enable gradient propagation. The image stylization system 226 can use a feature extractor, such as a pre-trained machine learning (ML) model, to compute a set of features for a set of source domain images and/or a set of target domain images.

Custom Loss The image stylization system 226 adds a custom loss term to a base or default loss function being minimized as part of training or fine-tuning an image generation model 504. In the following, a consistency loss example is used as an illustrative example—however, other custom loss terms can be used as needed. A consistency loss term can measure a discrepancy, disagreement or distance between features computed for a first set of images and, respectively, for a second set of images. In some examples, the first set of images includes source domain images generated during an initialization of image generation model 504 (e.g., the initialization of a pre-trained ML model used by the image generation model 504). In some examples, the second set of images includes candidate target domain images that are generated during training or fine-tuning image generation model 504 (e.g., the training or fine-tuning of a ML model, such as the ML model pre-trained on the source domain, used by the image generation model 504). As previously mentioned, the ML models generating the source domain images and the candidate target domain images can be the same or different (see, e.g., the discussion of image generation models above).

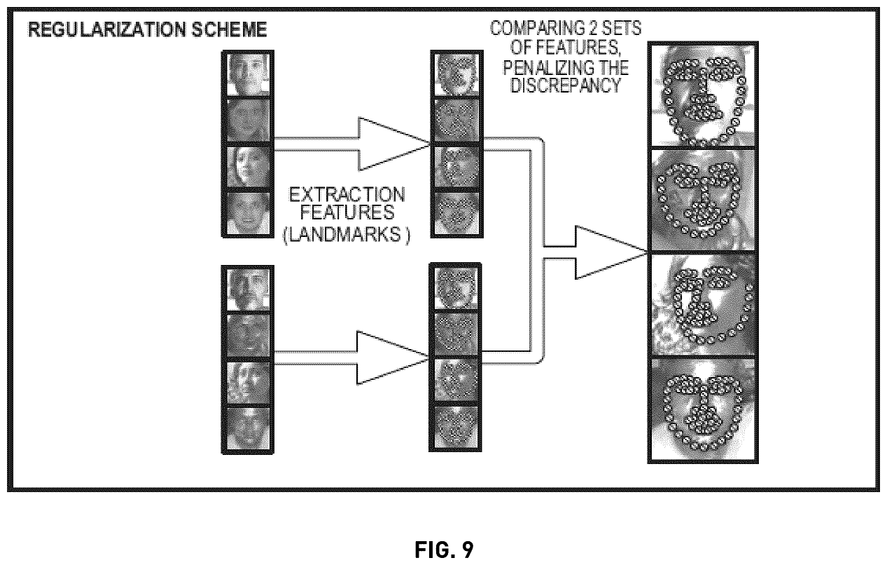

In some examples, the two feature sets represent the same type of features. In some examples, for an image pair with two corresponding feature sets, a modified training regime for image generation model 504 computes one or more distance measures between values of corresponding features. The modified training regime thus computes one or more image pair-level distances between the two corresponding feature sets (see, e.g., FIG. 9). Computing an image pair-level distance can use measures such as mean squared error (MSE), root mean squared error (RMSE), or other measures. The modified training regime of image generation model 504 computes a consistency loss term by aggregating image pair-level distances over a set of image pairs that includes source domain images and corresponding candidate target domain images. The consistency loss term can use an appropriate function (MSE, RMSE, etc.) to aggregate the image pair-level distances.

In some examples, multiple consistency loss terms can be added to a default loss function. Each consistency loss term can be multiplied by a weight before being added to a default loss function. Each consistency loss term can correspond to a subset of image features, such as facial landmarks, blend shapes, a subset of either, or other image feature subsets.

### Image Translation Model

In some examples, image stylization system 226 uses image translation model 506 to perform a transformation of an image from a source domain to a corresponding image in a target domain (e.g., an image-to-image transformation). The image translation model 506 corresponds to, or can use, one or more ML models (e.g., image-to-image translation models). The image translation model 506 can use one or more supervised, semi-supervised, or unsupervised models. In the disclosure herein, fine-tuning, training or running an image translation model 506 refers to either fine-tuning, training or running the image translation model itself, and/or training or running one or more ML models used by the image translation model 506.

The image translation model 506 can be trained using a training set that includes paired images, such as a source domain image paired with a corresponding target domain image. The image translation model 506 can alternatively be trained using a training set that includes unpaired images. For example, the training set can source domain images and target domain images without an explicit pairwise correspondence. The image translation model 506 can use a GAN model (e.g., Deep GAN, DCGAN, Pix2Pix, U-Net GAN, CycleGAN, PatchGan, etc.), or other ML models that can be used for image-to-image translation.

In some examples, image stylization system 226 can use multiple image translation models 506. For example, a second image translation model is trained using a training set that incorporates sampled output from a first trained image translation model, in a manner similar to that described for image generation models 504 above. In some examples, output produced by a trained image translation model 506 can be sampled and/or used to augment or replace a training set for an image generation model 504.

In some examples, an image stylization system 226 modifies the training regime of an image translation model 506 by adding one or more custom loss terms similar to those described above in relation to the modified training regime of image generation model 504. As described above, a consistency loss term computes a discrepancy, disagreement or distance between corresponding sets of features computed for a first set of images and a second set of images. In the case of an image translation model 506, a first set of images can include source domain images, for example provided to an image translation model 506 model as part of its training set. A second set of images can include candidate target domain images that are generated by image translation model 506 as part of its training. In some examples, a first set of images includes target domain images generated during the training of image translation model 506, while a second set of images includes target domain images provided to the image translation model 506 as part of its training set.

### Image Combination System

An image combination system 508 can generate new images by combining or blending images. In some examples, images with high stylization strength and low identity preservation are combined with images with low stylization strength and high identity preservation to obtain images with both high stylization strength and high identity preservation, or in order to balance stylization strength and identity preservation.

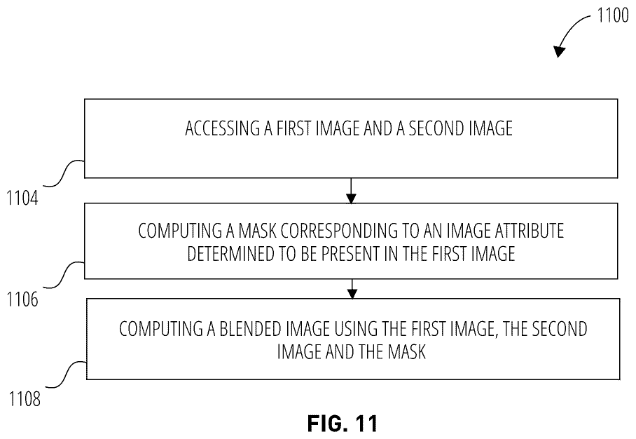

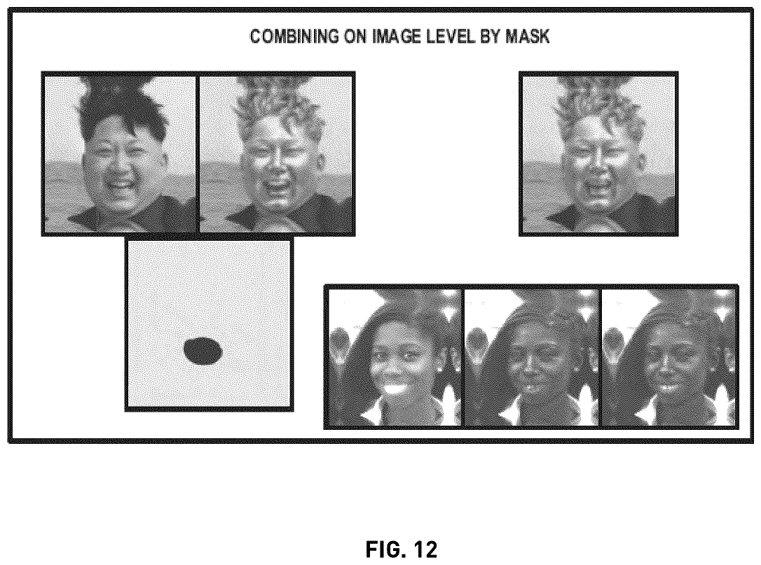

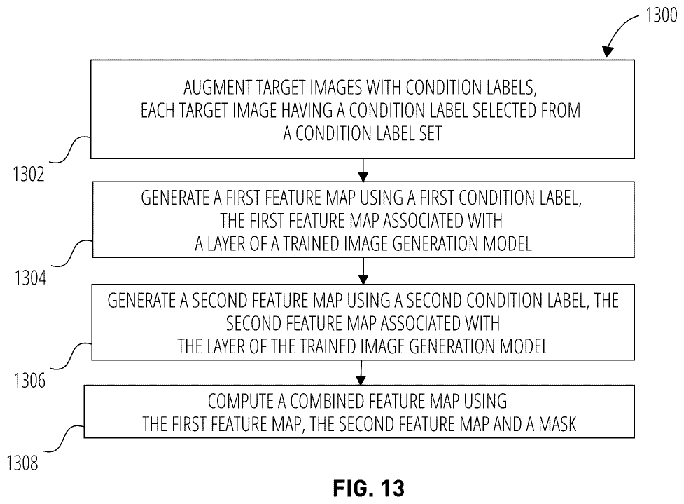

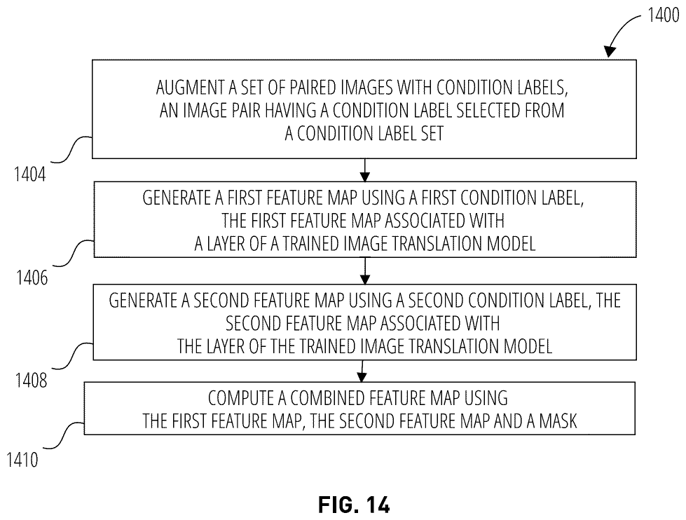

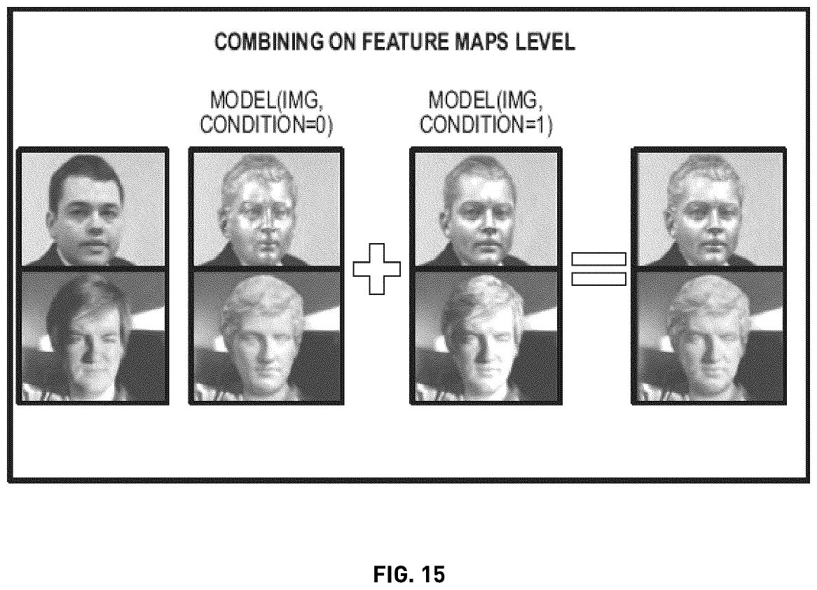

In some examples, image combination is performed at the level of images (see, e.g, the flowchart in FIG. 11 and/or examples in FIG. 12). In some examples, image combination is performed at the level of features maps, using for example an image producing model such as image generation model 504 (see, e.g., FIG. 13), or image translation model 506 (see, e.g., FIG. 14, FIG. 15). In some examples, one or more of the images to be combined is a target domain image. In some examples, one or more of the images to be combined is a source domain image used as an image with high identity preservation. In some examples, the image dataset construction system 502 can use the image combination system 508 to generate a new or an adjusted image dataset used for training or retraining the image generation model 504 or the image translation model 506.

### UI Functionality

In some examples, the image stylization system 226 or one or more of its components have associated UI functionality that enables the system to receive and/or incorporate input from users with respect to their preferences. The UI functionality can enable the system to visualize the effects of various stylization parameters, and/or iteratively refine the output of the image stylization pipeline. Users can include consumers or application users, annotators, professional designers, artists, or other users.

In some examples, the UI enables the upload of source images by users, and/or receives selections of one or more desired target domains for stylization. The UI can provide sliders, dropdowns, or other interactive elements to adjust the balance between identity preservation and stylization strength, the levels of one or more image properties, and so forth, The UI can allow the image stylization system to provide real-time or visual feedback, in the form of previews, to users providing real-time input with respect to a desired property level (e.g., high stylization strength, low identity preservation, etc).

In some examples, the UI can receive input from users that marks or identifies specific areas or landmarks in the source image that should be preserved or emphasized in the stylized version of the image. Such information can be automatically incorporated in the computation of a custom loss, such as a consistency loss. The UI can also receive annotation information corresponding to the levels of stylization strength and/or identity preservation one or more images exhibit.

In some examples, the UI can include user selectable UI elements that enable the system to fine-tune image stylization effects at a granular level, possibly including layer adjustments, filter applications, or even responding to direct manipulation of the image's feature maps. Such control allows for the creation of highly customized and intricate stylized images suitable for commercial or artistic use.

FIG. 6 illustrates different types of image stylization outputs produced by image translation model 506 for an image and chosen target domains, according to some examples. Given an input face image, the first row of “v” images showcases example stylized images with high stylization strength (e.g., high quality “marble statue” or “bronze statue” stylization), but low identity preservation. For example, the person in the stylized images is not easily recognizable as the person in the input image. The second row, consisting of “v1” images, showcases example stylized images with low, or lower, stylization strength and high, or higher, identity preservation.

### An Image Stylization System Process Flow

FIG. 7 is a flowchart illustrating a process flow 700 for image stylization system 226, according to some examples.

At operation 702, an image dataset construction system 502 of image stylization system 226 constructs a set of target domain images. At operation 704, image stylization system 226 uses the set of target domain images to train an image generation model, for example an instance of image generation model 504.

### Repeated Model Training

At operation 706, image stylization system 226, for example via image dataset construction system 502. uses a trained image generation model 504 to generate a second set of target domain images. This operation is accomplished, for example, by sampling from the output of the image generation model 504 trained on the first set of target domain images. A second image generation model 504 can be trained based on the second set of target domain images. Thus, model training can be repeated, resulting in multiple image generation models, where later models are trained or re-trained based on the output of earlier used models. Repeated model training enables image stylization system 226 to produce image generation models with increased identity preservation capabilities (see, e.g., FIG. 8). The image stylization system 226 can execute or repeat model training a preselected number of times (e.g., N=3 or 4), or an automatically determined number of times. For example, the image stylization system 226 can automatically select sample output images at a given point and perform an analysis of image properties such as overall or regional color cohesiveness, presence of predetermined tones or colors, prominence of facial features of interest, or other properties. If the analysis finds that one or more of the image properties are present to a pre-determined extent (e.g., based on pre-set thresholds), the model training can end; otherwise, it can continue. In some examples, image stylization system 226 can automatically select output images at a given iteration of the training, and obtain an annotator-provided, quality-specific assessment via a UI, as described earlier in relation to the image dataset construction system 502. If the assessment exceeds a pre-set threshold, the training can stop; otherwise, it can be resumed.

At operation 708, the image stylization system 226 uses the second trained image generation model to generate a set of paired images, each pair containing an image from the source domain and a corresponding image from the target domain (see, e.g., FIG. 5 for generation details).

In some examples, the image stylization system 226 can bypass retraining entirely, and use the original trained image generation model of operation 704 as part of generating the set of paired images (as detailed in FIG. 5). Alternatively, successive image generation models can be trained—in such cases, given a last set of generated target domain images, a final image generation model is trained on this last set and used part of generating the set of paired images.

At operation 710, the image stylization system 226 evaluates a quality of the set of generated set of paired images. In some examples, an evaluation is conducted by automatically sampling a subset of the paired images set and presenting it to a human annotator who provides an assessment with respect to a quality of interest (e.g., identity preservation quality, stylization strength quality). In some examples, an evaluation is conducted by automatically selecting sample output image pairs at a given step and performing an analysis of image properties as described earlier in relation to operation 706. Operation 710 can be executed, for example, by the image dataset construction system 502.

At operation 712, image dataset construction system 502 constructs an adjusted set of image pairs, based on the evaluated quality of interest. In an illustrative example, the image dataset construction system 502 assesses that the target domain images in the set of generated image pairs from operation 710 have low identity preservation. In this example, image dataset construction system 502 constructs an adjusted set of paired images to improve identity preservation. The image dataset construction system 502 calls image combination system 508 to generate a set of combined images based on two image sets produced by two trained image generation models with different output characteristics (see FIG. 11 and FIG. 12 for example combination methods). The image dataset construction system 502 uses the set of combined images in the generation of the adjusted set of paired images.

At operation 714, the image stylization system 226 uses an image translation model 506, trained on the adjusted set of paired images, to translate example source images into output images from the target domain.

In some examples, image stylization system 226 can repeat a training operation for any image producing model, such as image generation model 504 (as above), or image translation model 506. The image stylization system 226 can augment or replace an initial adjusted set of paired images by repeating a training operation for image translation model 506, in a manner similar to that described above for image generation model 504. The image stylization system 226 can use multiple image translation models, where later models are trained using sampled output from earlier trained models, in a manner similar to that described above for an image generation model 504. The selection of the number of training operations or iterations can also be done similarly to the previously described selection for image generation model 504.

In some examples, image stylization system 226 can use images selected from an adjusted dataset of paired images to construct a new set of target domain images to be used for training/re-training by an image generation model, such as image generation model 504. The adjusted dataset of paired images can be an initial dataset, or a dataset augmented or replaced by means of repeated training or re-training.

FIG. 8 is an illustration of image generation model outputs, according to some examples. Image generation models 504 can be trained on sampled output from other previously trained or re-trained image generation models 504. Given example images from a source domain, M1 output images in FIG. 8 show example related outputs from an image generation model M1 that is trained to generate images from a target domain, such as a statue domain (see, e.g., FIG. 5 for details of generating related source and target domain images). The images generated by model M1 have target domain characteristics (e.g., “statue” characteristics). The images show high stylization strength. They also show low, or limited, identity preservation. M2 output images correspond to the output of an example second image generation model trained on sampled output from image generation model M1.

Given the example images from the source domain, the related output images generated by a M2 model show increased identity preservation with respect to M1 output images. Their target domain characteristics, related to their “statue” appearance, appear attenuated with respect to M1 output.

As illustrated in FIG. 8, by the fourth image generation model trained in this fashion, output images can start to show high identity preservation, and/or low stylized strength. For example, M4 output does not appear to be fully in the target domain—for example, the “statue” quality of the example images appears diluted.

FIG. 9 is an illustration of feature sets for two sets of images. The features include identity-related features such as facial landmarks. The sets of images include a set of source domain images and, respectively, a set of corresponding candidate target domain images. FIG. 9 also illustrates examples of discrepancies between the sets of features: specifically, the third column shows examples of superimposed facial landmarks extracted for the two sets of images.

FIG. 10 is an illustration of results of adding a custom loss to a base loss in model training, according to some examples. The left-most column shows example source domain images. The middle column shows related candidate target domain images generated by an image generation model 504 trained using a base loss function (see, e.g., FIG. 5 for details). The right-most column shows candidate target domain images related to the source domain images that are generated by an image generation model 504 trained using an augmented loss function. The augmented loss function adds a custom loss term, represented by a consistency loss, to the base loss. The consistency loss is computed based on penalizing a mismatch between feature sets that include facial landmarks and blend shapes. The images in the right-most column show improved identity preservation over those in the middle column, exemplifying the beneficial effect of adding a custom loss to a base loss function.

### Direct Image Combination

FIG. 11 is a flowchart illustrating an image combination method 1100, as implemented by image stylization system 226 using image combination system 508, according to some examples.

At operation 1104, image combination system 508 accesses a first image and a second image. At operation 1106, image combination system 508 determines, for an image attribute of interest, a mask indicating the position of the image attribute with respect to the image. Example attributes of interest include a mouth, eye, teeth shape, or other attributes. In some examples, the mask corresponds to a 2D array with the same dimensions as a 2D image array, the values in the mask array being 0 everywhere except for the entries corresponding to the image attribute locations. The mask can be computed based on the output of a segmentation model. The mask can be computed based on previously detected facial landmarks, such as landmarks corresponding to an inner area of a mouth, corresponding to an eye, or corresponding to other landmarks.

The mask can be dilated, eroded or subjected to other morphological operations. The image combination system 508 applies one or more transformations to an image and/or a mask in order to improve the quality on the mask borders, for example by reducing noise artifacts. Example transformations include morphological operations, image filtering (e.g., applying a Gaussian filter), or other transformations.

At operation 1108, image combination system 508 computes a combined image based on the first image, the second image, and/or a mask such as the one at operation 1106 (see, e.g., FIG. 12). The image combination system 508 can compute a combined image by using an alpha blending (or alpha compositing) method, or a Poisson blending method.

In some examples, at least one of the images to be combined is generated by an image generation model 504, or by an image translation model 506. In some examples, at least one of the images to be blended is a target domain image, or a source domain image. For example, the source domain image can be used as an extreme example of an image with high identity preservation.

FIG. 12 is an illustration of image combination outputs, according to some examples. Image combination can be performed using method 1100, as implemented by the image combination system 508. In some examples, image combination system 508 computes a mask corresponding to a detected location of an attribute related to identity preservation, such as a mouth shape, or teeth shape within a mouth area, among other examples. The image combination system 508 combines images using a mask, thereby ensuring that the combined image retains a desired version of the detected attribute.

Feature Map-Level Image Combination with Image Generation Models

FIG. 13 is a flowchart illustrating a portion of an image combination method 1300, as implemented by image stylization system 226 using image combination system 508, according to some examples. Method 1300 combines feature maps produced by a trained image generation model 504.

At operation 1302, an image stylization system 226, for example via the image dataset construction system 502, augments a set of target domain images by including associated condition labels for one or more conditions. In some examples, a target domain image is associated with a condition label for a particular condition, each condition label belonging to a set of pre-determined values and/or indicating a characteristic of interest for the image. For example, the condition can be identity preservation, and/or the set of pre-determined values can be {0, 1}, where 0 denotes a “low identity preservation” image, and 1 denotes a “high identity preservation” image. In some examples, other labeling schemes can be used (e.g., 0 for low identity preservation, 1 for medium identity preservation, 2 for high identity preservation). Conditions can refer to the level of identity preservation, level of stylized strength, or other characteristics. In some examples, a condition label for an image and a given condition is received by the image stylization system 226 via a user-selectable element of a UI. In some examples, the condition label is automatically assigned based on automatically detecting one or more characteristics of the image that are correlated with, or proxies for, the desired property. In some examples, an image generation model 504 is trained or fine-tuned on the augmented set of target domain images. The image generation model 504 can be a conditional image generation model, using for example a Conditional GAN (e.g., Pix2Pix, DCGAN, U-Net Conditional GAN, etc.).

At operation 1304, trained image generation model 504 generates a first feature map at one of its layers. The first feature map is generated while running the trained image generation model 504 after receiving a first set of inputs including a first condition label associated with particular condition (e.g., 0, corresponding to “low identity preservation”, associated with an identity preservation condition). In some examples, the first set of inputs includes input noise.

At operation 1306, trained image generation model 504 generates a second feature map at one of its layers (e.g., the same layer as in operation 1304). The second feature map is generated while running the trained image generation model 504 on a second set of inputs that includes a second condition label (e.g., 1, corresponding to “high identity preservation”, associated with the identity preservation condition). In some examples, the second set of inputs includes input noise. In some examples, the first set of inputs and the second set of inputs are the same, with the exception of the condition label (e.g., the same noise inputs are used). In some examples, the first feature map and the second feature map are generated by a trained image generation model 504 running layer-by-layer with both sets of inputs, where the inputs (excluding the condition labels for the condition of interest) are the same in the first and in the second sets of inputs.

At operation 1308, the method 1300 combines the first feature map with the second feature map using a mask that corresponds to a location of an attribute of interest. In some examples, the mask is computed based on a first output of trained image generation model 504 run on the first input set (including the fixed first condition label), and/or on a second output of the trained image generation model 504 run on the second input set (including the fixed second condition label), where the input sets are the same with the exception of the included condition labels.

In some examples, a combined or blended feature map generated at a particular layer is provided as input to a successive layer of the conditional image generation model 504. This operation can be repeated for additional layers until a final combined feature map is used to produce a combined output image. In some examples, a mask can be computed at a selected layer of image generation model 504 and/or used in the generation of the combined or blended feature map. In some examples, the mask is computed at the same layer where the combined or blended feature map is generated, or at a different layer. In some examples, multiple combined feature maps are generated at multiple layers. In some examples, by implementing method 1300, image stylization system 226 better balances identity preservation and stylization strength, as well as enhances preservation of features of interest, for example by reducing the incidence and severity of mask border artifacts.

Feature Map-Level Image Combination with Image Translation Models

FIG. 14 is a flowchart illustrating a portion of an image combination method 1400, as implemented by image stylization system 226 using image combination system 508, according to some examples. Method 1400 combines feature maps produced by a trained image translation model 506.

At operation 1404, image stylization system 226, for example via the image dataset construction system 502, augments a training set of paired images, such as source domain images and corresponding target domain images, by including associated condition labels. In some examples, each training set element (e.g., image pair) is associated with a condition label whose value belongs to a set of pre-determined values and/or indicates a characteristic of interest for the training set element (e.g., for an image pair, or for one of the image pair elements). For example, a condition label value can be drawn from the set {0, 1}, where 0 denotes “low identity preservation”, and 1 denotes “high identity preservation”. Characteristics of interest include level of identity preservation, level of stylized strength, or other characteristics. An image translation model 506 model is trained on such an augmented training set. The image translation model 506 can be a conditional image translation model, using for example a Conditional GAN (e.g., Pix2Pix, DCGAN, U-Net Conditional GAN).

Operations 1406 through 1410 are analogous to operations 1304 through 1308 as implemented using one or more trained image translation models 506 rather than one or more trained image generation models 504 as in FIG. 13.

FIG. 15 is an illustration of outputs of an image combination method, such as method 1400, as implemented by image stylization system 226, according to some examples. The column corresponding to “condition=0” shows examples of images generated by a trained conditional image translation model 506 run on an input set including an input image and an input condition label set to 0. The input condition label set to 0 corresponds, for example, to “low identity preservation” (or to “high stylized strength”). The column corresponding to “condition=1” shows examples of images generated by the trained conditional image translation model 506 when run on an input set including an input image and an input condition label set to 1. The input condition label set to 1 corresponds to “high identity preservation” (or to “low stylized strength”). The final column shows a final combined image generated by a feature map-level image combination method such as method 1400. The combined image has better identity preservation than the examples in the column corresponding to “condition=0”, while retaining a high level of stylized strength.

### Machine Architecture

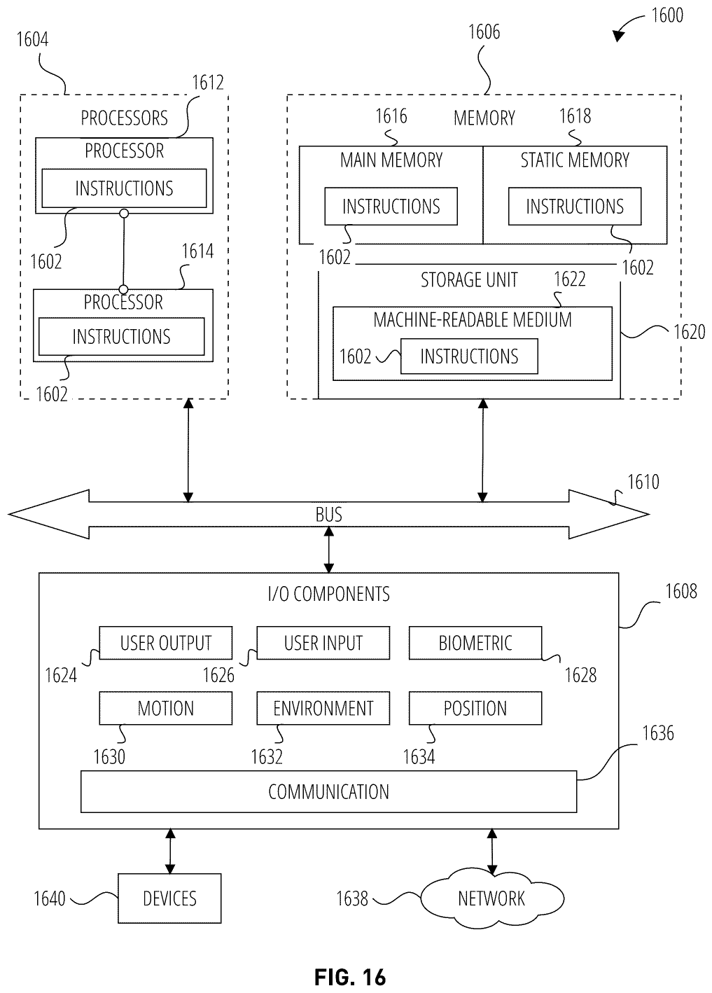

FIG. 16 is a diagrammatic representation of the machine 1600 within which instructions 1602 (e.g., software, a program, an application, an applet, an app, or other executable code) for causing the machine 1600 to perform any one or more of the methodologies discussed herein may be executed. For example, the instructions 1602 may cause the machine 1600 to execute any one or more of the methods described herein. The instructions 1602 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1602, sequentially or otherwise, that specify actions to be taken by the machine 1600. Further, while a single machine 1600 is illustrated, the term “machine” shall also be taken to include a collection of machines that individually or jointly execute the instructions 1602 to perform any one or more of the methodologies discussed herein. The machine 1600, for example, may comprise the user system 102 or any one of multiple server devices forming part of the interaction server system 110. In some examples, the machine 1600 may also comprise both client and server systems, with certain operations of a particular method or algorithm being performed on the server-side and with certain operations of the particular method or algorithm being performed on the client-side.

The machine 1600 may include processors 1604, memory 1606, and input/output I/O components 1608, which may be configured to communicate with each other via a bus 1610. In an example, the processors 1604 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1612 and a processor 1614 that execute the instructions 1602. The term “processor” is intended to include multi-core processors that may comprise two or more independent processors (sometimes referred to as “cores”) that may execute instructions contemporaneously. Although FIG. 16 shows multiple processors 1604, the machine 1600 may include a single processor with a single-core, a single processor with multiple cores (e.g., a multi-core processor), multiple processors with a single core, multiple processors with multiples cores, or any combination thereof.

The memory 1606 includes a main memory 1616, a static memory 1618, and a storage unit 1620, both accessible to the processors 1604 via the bus 1610. The main memory 1606, the static memory 1618, and storage unit 1620 store the instructions 1602 embodying any one or more of the methodologies or functions described herein. The instructions 1602 may also reside, completely or partially, within the main memory 1616, within the static memory 1618, within machine-readable medium 1622 within the storage unit 1620, within at least one of the processors 1604 (e.g., within the processor's cache memory), or any suitable combination thereof, during execution thereof by the machine 1600.

The I/O components 1608 may include a wide variety of components to receive input, provide output, produce output, transmit information, exchange information, capture measurements, and so on. The specific I/O components 1608 that are included in a particular machine will depend on the type of machine. For example, portable machines such as mobile phones may include a touch input device or other such input mechanisms, while a headless server machine will likely not include such a touch input device. It will be appreciated that the I/O components 1608 may include many other components that are not shown in FIG. 16. In various examples, the I/O components 1608 may include user output components 1624 and user input components 1626. The user output components 1624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1608 may include biometric components 1628, motion components 1630, environmental components 1632, or position components 1634, among a wide array of other components. For example, the biometric components 1628 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1630 include acceleration sensor components (e.g., accelerometer), gravitation sensor components, rotation sensor components (e.g., gyroscope).

The environmental components 1632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1634 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1608 further include communication components 1636 operable to couple the machine 1600 to a network 1638 or devices 1640 via respective coupling or connections. For example, the communication components 1636 may include a network interface component or another suitable device to interface with the network 1638. In further examples, the communication components 1636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1640 may be another machine or any of a wide variety of peripheral devices (e.g., a peripheral device coupled via a USB).

Moreover, the communication components 1636 may detect identifiers or include components operable to detect identifiers. For example, the communication components 1636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1636, such as location via Internet Protocol (IP) geolocation, location via Wi-Fi® signal triangulation, location via detecting an NFC beacon signal that may indicate a particular location, and so forth.

The various memories (e.g., main memory 1616, static memory 1618, and memory of the processors 1604) and storage unit 1620 may store one or more sets of instructions and data structures (e.g., software) embodying or used by any one or more of the methodologies or functions described herein. These instructions (e.g., the instructions 1602), when executed by processors 1604, cause various operations to implement the disclosed examples.

The instructions 1602 may be transmitted or received over the network 1638, using a transmission medium, via a network interface device (e.g., a network interface component included in the communication components 1636) and using any one of several well-known transfer protocols (e.g., hypertext transfer protocol (HTTP)). Similarly, the instructions 1602 may be transmitted or received using a transmission medium via a coupling (e.g., a peer-to-peer coupling) to the devices 1640.

### Software Architecture

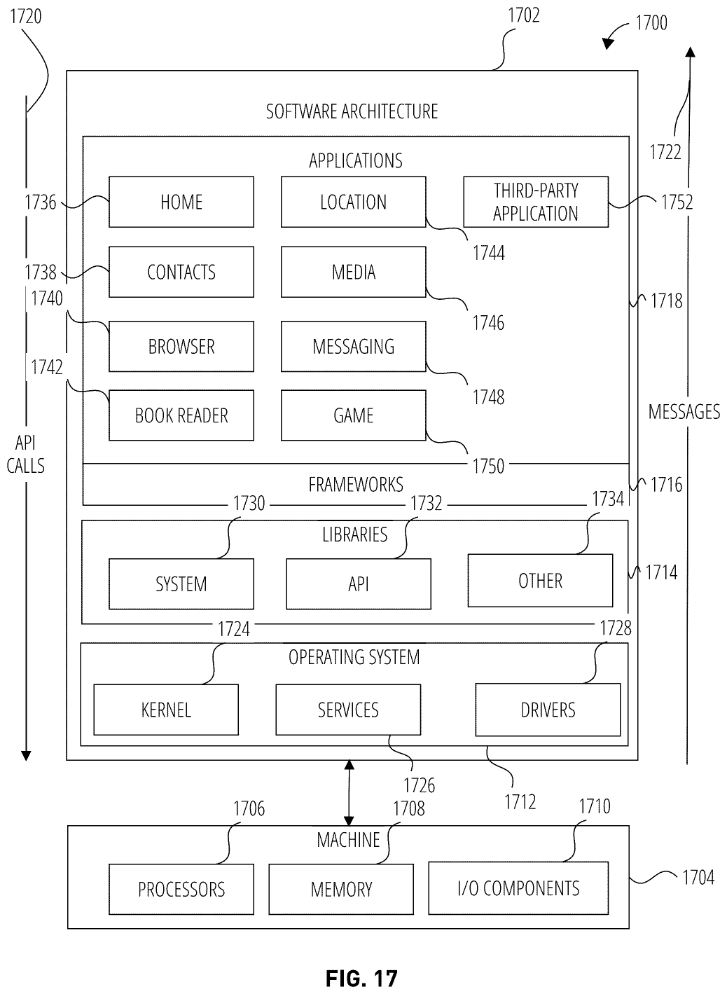

FIG. 17 is a block diagram 1700 illustrating a software architecture 1702, which can be installed on any one or more of the devices described herein. The software architecture 1702 is supported by hardware such as a machine 1704 that includes processors 1706, memory 1708, and I/O components 1710. In this example, the software architecture 1702 can be conceptualized as a stack of layers, where each layer provides a particular functionality. The software architecture 1702 includes layers such as an operating system 1712, libraries 1714, frameworks 1716, and applications 1718. Operationally, the applications 1718 invoke API calls 1720 through the software stack and receive messages 1722 in response to the API calls 1720.

The operating system 1712 manages hardware resources and provides common services. The operating system 1712 includes, for example, a kernel 1724, services 1726, and drivers 1728. The kernel 1724 acts as an abstraction layer between the hardware and the other software layers. For example, the kernel 1724 provides memory management, processor management (e.g., scheduling), component management, networking, and security settings, among other functionalities. 1726 can provide other common services for the other software layers. The drivers 1728 are responsible for controlling or interfacing with the underlying hardware. For instance, the drivers 1728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1714 provide a common low-level infrastructure used by the applications 1718. The libraries 1714 can include system libraries 1730 (e.g., C standard library) that provide functions such as memory allocation functions, string manipulation functions, mathematic functions, and the like. In addition, the libraries 1714 can include API libraries 1732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1714 can also include a wide variety of other libraries 1734 to provide many other APIs to the applications 1718.

The frameworks 1716 provide a common high-level infrastructure that is used by the applications 1718. For example, the frameworks 1716 provide various graphical user interface (GUI) functions, high-level resource management, and high-level location services. The frameworks 1716 can provide a broad spectrum of other APIs that can be used by the applications 1718, some of which may be specific to a particular operating system or platform.

In an example, the applications 1718 may include a home application 1736, a contacts application 1738, a browser application 1740, a book reader application 1742, a location application 1744, a media application 1746, a messaging application 1748, a game application 1750, and a broad assortment of other applications such as a third-party application 1752. The applications 1718 are programs that execute functions defined in the programs. Various programming languages can be employed to create one or more of the applications 1718, structured in a variety of manners, such as object-oriented programming languages (e.g., Objective-C, Java, or C++) or procedural programming languages (e.g., C or assembly language). In a specific example, the third-party application 1752 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1752 can invoke the API calls 1720 provided by the operating system 1712 to facilitate functionalities described herein.

### Time-Based Access Architecture

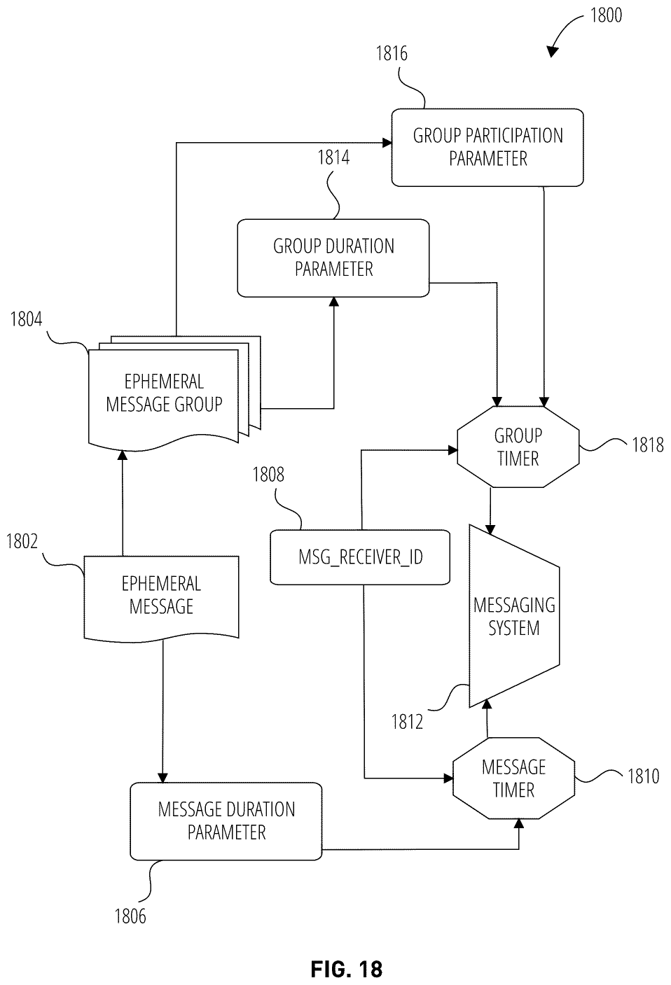

FIG. 18 is a schematic diagram illustrating an access-limiting process 1800, in terms of which access to content (e.g., an ephemeral message 1802 and associated multimedia payload of data) or a content collection (e.g., an ephemeral message group 1804) may be time-limited (e.g., made ephemeral).

An ephemeral message 1802 is shown to be associated with a message duration parameter 1806, the value of which determines the amount of time that the ephemeral message 1802 will be displayed to a receiving user of the ephemeral message 1802 by the interaction client 104. In some examples, an ephemeral message 1802 is viewable by a receiving user for up to a maximum of 10 seconds, depending on the amount of time that the sending user specifies using the message duration parameter 1806.

The message duration parameter 1806 and the message receiver identifier 1808 are shown to be inputs to a message timer 1810, which is responsible for determining the amount of time that the ephemeral message 1802 is shown to a particular receiving user identified by the message receiver identifier 1808. In particular, the ephemeral message 1802 will be shown to the relevant receiving user for a time period determined by the value of the message duration parameter 1806. The message timer 1810 is shown to provide output to a more generalized messaging system 1812, which is responsible for the overall timing of display of content (e.g., an ephemeral message 1802) to a receiving user.

The ephemeral message 1802 is shown in FIG. 18 to be included within an ephemeral message group 1804 (e.g., a collection of messages in a personal story, or an event story). The ephemeral message group 1804 has an associated group duration parameter 1814, a value of which determines a time duration for which the ephemeral message group 1804 is presented and accessible to users of the interaction system 100. The group duration parameter 1814, for example, may be the duration of a music concert, where the ephemeral message group 1804 is a collection of content pertaining to that concert. Alternatively, a user (either the owning user or a curator user) may specify the value for the group duration parameter 1814 when performing the setup and creation of the ephemeral message group 1804.

Additionally, each ephemeral message 1802 within the ephemeral message group 1804 has an associated group participation parameter 1816, a value of which determines the duration of time for which the ephemeral message 1802 will be accessible within the context of the ephemeral message group 1804. Accordingly, a particular ephemeral message group 1804 may “expire” and become inaccessible within the context of the ephemeral message group 1804 prior to the ephemeral message group 1804 itself expiring in terms of the group duration parameter 1814. The group duration parameter 1814, group participation parameter 1816, and message receiver identifier 1808 each provide input to a group timer 1818, which operationally determines, firstly, whether a particular ephemeral message 1802 of the ephemeral message group 1804 will be displayed to a particular receiving user and, if so, for how long. Note that the ephemeral message group 1804 is also aware of the identity of the particular receiving user as a result of the message receiver identifier 1808.

Accordingly, the group timer 1818 operationally controls the overall lifespan of an associated ephemeral message group 1804 as well as an individual ephemeral message 1802 included in the ephemeral message group 1804. In some examples, each and every ephemeral message 1802 within the ephemeral message group 1804 remains viewable and accessible for a time period specified by the group duration parameter 1814. In a further example, a certain ephemeral message 1802 may expire within the context of ephemeral message group 1804 based on a group participation parameter 1816. Note that a message duration parameter 1806 may still determine the duration of time for which a particular ephemeral message 1802 is displayed to a receiving user, even within the context of the ephemeral message group 1804. Accordingly, the message duration parameter 1806 determines the duration of time that a particular ephemeral message 1802 is displayed to a receiving user regardless of whether the receiving user is viewing that ephemeral message 1802 inside or outside the context of an ephemeral message group 1804.

The messaging system 1812 may furthermore operationally remove a particular ephemeral message 1802 from the ephemeral message group 1804 based on a determination that it has exceeded an associated group participation parameter 1816. For example, when a sending user has established a group participation parameter 1816 of 24 hours from posting, the messaging system 1812 will remove the relevant ephemeral message 1802 from the ephemeral message group 1804 after the specified 24 hours. The messaging system 1812 also operates to remove an ephemeral message group 1804 when either the group participation parameter 1816 for each and every ephemeral message 1802 within the ephemeral message group 1804 has expired, or when the ephemeral message group 1804 itself has expired in terms of the group duration parameter 1814.

In certain use cases, a creator of a particular ephemeral message group 1804 may specify an indefinite group duration parameter 1814. In this case, the expiration of the group participation parameter 1816 for the last remaining ephemeral message 1802 within the ephemeral message group 1804 will determine when the ephemeral message group 1804 itself expires. In this case, a new ephemeral message 1802, added to the ephemeral message group 1804, with a new group participation parameter 1816, effectively extends the life of an ephemeral message group 1804 to equal the value of the group participation parameter 1816.

Responsive to the messaging system 1812 determining that an ephemeral message group 1804 has expired (e.g., is no longer accessible), the messaging system 1812 communicates with the interaction system 100 (and, for example, specifically the interaction client 104) to cause an indicium (e.g., an icon) associated with the relevant ephemeral message group 1804 to no longer be displayed within a user interface of the interaction client 104. Similarly, when the messaging system 1812 determines that the message duration parameter 1806 for a particular ephemeral message 1802 has expired, the messaging system 1812 causes the interaction client 104 to no longer display an indicium (e.g., an icon or textual identification) associated with the ephemeral message 1802.

### Examples

Example 1 is a method comprising: constructing a set of target domain images; training an image generation model on the set of target domain images; generating a set of paired images using the trained image generation model, the set of paired images comprising at least a target domain image associated with a source domain image; evaluating a quality of the set of paired images; constructing an adjusted set of paired images based on the quality of the set of paired images; and generating output target domain images using an image translation model trained on the adjusted set of paired images.
In Example 2, the subject matter of Example 1 includes, wherein generating the set of paired images further comprises: pre-training the image generation model on a set of source domain images; generating the source domain image using the trained image generation model and a noise input; and generating the target domain image using the trained image generation model and the noise input.
In Example 3, the subject matter of Examples 1-2 includes, wherein generating the set of paired images further comprises: generating a second set of target domain images using the trained image generation model; and generating the set of paired images using a second image generation model trained on the second set of target domain images.
In Example 4, the subject matter of Examples 1-3 includes, wherein training the image generation model further comprises: minimizing a loss function comprising a custom loss; and computing the custom loss based on at least a set of source domain image features and a set of target domain image features.
In Example 5, the subject matter of Example 4 includes, wherein the computing of the custom loss further comprises computing a distance between the set of source domain image features and the set of target domain image features.
In Example 6, the subject matter of Examples 1-5 includes, wherein constructing an adjusted set of paired images further comprises: accessing a first image and a second image; computing a mask corresponding to an image attribute, the image attribute determined to be present in the first image; and computing a combined image using the first image, the second image and the mask.
In Example 7, the subject matter of Example 6 includes, wherein the first image is a first target domain image and the second image is a second target domain image.
In Example 8, the subject matter of Examples 6-7 includes, wherein the mask is computed using an image segmentation model or a facial landmarks extractor.
Example 9 is a method comprising: constructing an augmented set of target domain images comprising condition labels associated with target domain images; training an image producing model on the augmented set of target domain images, the image producing model being a conditional image producing model; generating a first feature map using the trained image producing model and a first input set including a first condition label, the first feature map associated with a layer of the trained image producing model; generate a second feature map using the trained image producing model and a second input set including a second condition label, the second feature map associated with the layer of the trained image producing model; computing a combined feature map using the first feature map, the second map, and a mask; and using the combined feature map in generating output target images using the trained image producing model.
In Example 10, the subject matter of Example 9 includes, generating a first output image by running the trained image producing model using an input set including the first condition label; generating a second output image by running the trained image producing model using an additional input set using the second condition label; computing the mask based on the first output image and the second output image.
In Example 11, the subject matter of Examples 9-10 includes, wherein the trained image producing model is a conditional image translation model or a conditional image generation label.
Example 12 is at least one machine-readable medium including instructions that, when executed by processing circuitry, cause the processing circuitry to perform operations to implement of any of Examples 1-11.
Example 13 is an apparatus comprising means to implement any of Examples 1-11.
Example 14 is a system to implement any of Examples 1-11.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A method comprising:
constructing a set of target domain images;
training an image generation model on the set of target domain images;
generating a set of paired images using the trained image generation model, the set of paired images comprising at least a target domain image associated with a source domain image;
evaluating a quality of the set of paired images;
constructing an adjusted set of paired images based on the quality of the set of paired images; and
generating output target domain images using an image translation model trained on the adjusted set of paired images.

2. The method of claim 1, wherein generating the set of paired images further comprises:
pre-training the image generation model on a set of source domain images;
generating the source domain image using the trained image generation model and a noise input; and
generating the target domain image using the trained image generation model and the noise input.

3. The method of claim 1, wherein generating the set of paired images further comprises:
generating a second set of target domain images using the trained image generation model; and
generating the set of paired images using a second image generation model trained on the second set of target domain images.

4. The method of claim 1, wherein training the image generation model further comprises:
minimizing a loss function comprising a custom loss; and
computing the custom loss based on at least a set of source domain image features and a set of target domain image features.

5. The method of claim 4, wherein the computing of the custom loss further comprises computing a distance between the set of source domain image features and the set of target domain image features.

6. The method of claim 1, wherein constructing an adjusted set of paired images further comprises:
accessing a first image and a second image;
computing a mask corresponding to an image attribute, the image attribute determined to be present in the first image; and
computing a combined image using the first image, the second image and the mask.

7. The method of claim 6, wherein the first image is a first target domain image and the second image is a second target domain image.

8. The method of claim 6, wherein the mask is computed using an image segmentation model or a facial landmarks extractor.

9. A method comprising:
constructing an augmented set of target domain images comprising condition labels associated with target domain images;
training an image producing model on the augmented set of target domain images, the image producing model being a conditional image producing model;
generating a first feature map using the trained image producing model and a first input set including a first condition label, the first feature map associated with a layer of the trained image producing model;
generate a second feature map using the trained image producing model and a second input set including a second condition label, the second feature map associated with the layer of the trained image producing model;
computing a combined feature map using the first feature map, the second map, and a mask; and
using the combined feature map in generating output target images using the trained image producing model.

10. The method of claim 9, further comprising:
generating a first output image by running the trained image producing model using an input set including the first condition label;
generating a second output image by running the trained image producing model using an additional input set using the second condition label;
computing the mask based on the first output image and the second output image.

11. The method of claim 9, wherein the trained image producing model is a conditional image translation model or a conditional image generation label.

12. A computing apparatus comprising:
at least one processor; and
a memory storing instructions that, when executed by the at least one processor, configure the apparatus to:
construct a set of target domain images;
train an image generation model on the set of target domain images;
generate a set of paired images using the trained image generation model, the set of paired images comprising at least a target domain image associated with a source domain image;
evaluate a quality of the set of paired images;
construct an adjusted set of paired images based on the quality of the set of paired images; and
generate output target domain images using an image translation model trained on the adjusted set of paired images.

13. The computing apparatus of claim 12, wherein generating the set of paired images further comprises:
generating a second set of target domain images using the trained image generation model; and
generating the set of paired images using a second image generation model trained on the second set of target domain images.

14. The computing apparatus of claim 12, wherein generating the set of paired images further comprises:
pre-training the image generation model on a set of source domain images;
generating the source domain image using the trained image generation model and a noise input; and
generating the target domain image using the trained image generation model and the noise input.

15. The computing apparatus of claim 12, wherein training the image generation model further comprises:
minimizing an augmented loss function, the augmented loss function to include a custom loss; and
computing the custom loss based on at least a set of source domain image features and a set of target domain image features.

16. The computing apparatus of claim 15, wherein the computing of the custom loss further comprises computing a distance between the set of source domain image features and the set of target domain image features.

17. The computing apparatus of claim 12, wherein constructing an adjusted set of paired images comprises:
accessing a first image and a second image;
computing a mask corresponding to an image attribute, the image attribute determined to be present in the first image; and
computing a combined image using the first image, the second image and the mask.

18. A non-transitory computer-readable storage medium, the computer-readable storage medium including instructions that when executed by at least one processor, cause the at least one processor to:
construct a set of target domain images;
generate a set of paired images using an image generation model trained on the set of target domain images, the set of paired images to contain a source domain image and a corresponding target domain image;
evaluate a quality of the set of paired images;
construct an adjusted set of paired images based on the quality of the set of paired images; and
generate output target domain images using an image translation model trained on the adjusted set of paired images.

19. A computing apparatus comprising:
a processor; and
a memory storing instructions that, when executed by the processor, configure the apparatus to:
construct an augmented set of target domain images comprising condition labels associated with target domain images;
train an image producing model on the augmented set of target domain images, the image producing model being a conditional image producing model;
generate a first feature map using the trained image producing model and a first input set including a first condition label, the first feature map associated with a layer of the trained image producing model;
generate a second feature map using the trained image produce model and a second input set including a second condition label, the second feature map associated with the layer of the trained image producing model;
compute a combined feature map using the first feature map, the second map, and a mask; and
using the combined feature map in generating output target images using the trained image producing model.

20. A non-transitory computer-readable storage medium, the computer-readable storage medium including instructions that when executed by a computer, cause the computer to:
construct an augmented set of target domain images comprising condition labels associated with target domain images;
train an image producing model on the augmented set of target domain images, the image producing model being a conditional image producing model;
generate a first feature map using the trained image producing model and a first input set including a first condition label, the first feature map associated with a layer of the trained image producing model;
generate a second feature map using the trained image produce model and a second input set including a second condition label, the second feature map associated with the layer of the trained image producing model;
compute a combined feature map using the first feature map, the second map, and a mask; and
using the combined feature map in generating output target images using the trained image producing model.
